(19) United States
(12) Patent Application Publication
(10) Pub. No.: US 2008/0061932 A1
(43) Pub. Date: Mar. 13, 2008

(54) METHOD FOR LOCKING A VEHICLE

(76) Inventor: Stefan Hermann, Kofering (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/851,272

(22) Filed: Sep. 6, 2007

(30) Foreign Application Priority Data
Sep. 13, 2006 (DE) 10 2006 042 944.3

(51) Int. Cl. G05B 19/00

(52) U.S. Cl. 340/5.72

(57) ABSTRACT

In a method for locking a motor vehicle (FZ), in which an opening state of at least one door of a vehicle (FZ) is detected by means of a door sensor (TSS), in addition an authorization signal (BS) is transmitted to a mobile identification transmitter (IDG) by means of a vehicle-side transceiver device (SE) if a closed state of the least one door has been detected, with the authorization signal authorizing the mobile identification transmitter to lock the motor vehicle. Finally the mobile identification transmitter includes an identification transmitter-side transceiver device (SEI) for receiving the authorization signal (BS), for emitting one or more request signals (ANS2) after receiving the authorization signal, and for transmitting a locking signal to the motor vehicle, if no relevant response signal has been received from the vehicle to a predetermined number (AZ) of request signals.

### CROSS-REFERENCE TO RELATED APPLICATIONS

This application claims priority to German Patent Application Number 10 2006 042 944.3 filed on Sep. 13, 2006, and which is incorporated herein by reference in its entirety.

### TECHNICAL FIELD

The present invention relates to a method for locking a vehicle or at least one door of the vehicle, as well as to an access arrangement for a vehicle.

### BACKGROUND

To prevent unauthorized access to a vehicle, especially a motor vehicle, modern access authorization systems or access arrangements in vehicles use electronic security systems, in which, for authentication of a user, data communication is undertaken between a first communication device of the vehicle and a second communication device in a user's mobile identification transmitter. To this end request signals are initially emitted by the first communication device of the vehicle at regular intervals with a specific field strength in order to check whether a mobile identification transmitter is located in the proximity area around the vehicle. If a mobile identification transmitter approaches the vehicle and can finally receive its request signals, it will wait to receive a request signal in order to initiate an authentication process. In such cases data telegrams are exchanged in which the mobile identification transmitter eventually transfers its authentication code to the motor vehicle. On successful checking of the authentication code it is then possible for a user who is directly adjacent to the motor vehicle, to unlock the corresponding vehicle door or all doors by activating a door handle. Since with the described method for gaining access to a vehicle no active actuation of a mechanical or electronic key has to be performed by a user, this type of access is also known as passive access authorization, and the corresponding access authorization systems are known as passive electronic access authorization systems.

Whereas in the passive access system just described access to the vehicle takes place on the basis of an automatic identification process between vehicle and user key, it would be equally advantageous to obtain enhanced convenience for the vehicle doors to be looked automatically after the user leaves the vehicle, for example after it is parked at the end of a journey. This problem is conventionally solved by vehicle locating a user or their assigned key and establishing whether the user or the key has been removed from the vehicle and is therefore passing through different surrounding areas of the vehicle in a specific time sequence. If a control device of the vehicle establishes that the user has passed through the surrounding areas in the prespecified time sequence, it issues a locking instruction to the closing device of a specific door or to the central locking device to lock one or more of the doors. This localization of the user or of the key by the vehicle to establish their passage through the different surrounding areas of the vehicle in the prespecified time sequence is however complicated and requires a great deal of processing effort in the vehicle.

### SUMMARY

A simple option for implementing automatic locking of the vehicle with little effort in terms of processes and equipment can be provided by an embodiment of a method for locking at least one door of a vehicle with the following steps: Detecting the open state of the least one door; Transmission of an authorization signal from the motor vehicle to a mobile identification transmitter, if a closed state of the least one door is detected, with the mobile identification transmitter being authorized by the authorization signal to lock the vehicle; Emission of one or more request signals from the mobile identification transmitter after receipt of the authorization signal; Sending of respective response signals with a predetermined intensity by of the vehicle in response to the receipt of a request signal; and Transmission of a locking signal from the mobile identification transmitter to the vehicle, if a relevant response signal has not been received for a predetermined number of request signals.

According to an enhancement, the authorization can be transmitted if an open state of at least one door has been detected before the closed state. According to a further enhancement, the authorization signal can be transmitted if a deactivated state of a drive device of the vehicle has been detected. According to a further enhancement, before transmission of the authorization signal the presence of the mobile identification transmitter in the vicinity of the vehicle can be checked. According to a further enhancement, the presence can be checked by a second request signal being sent out once or a number of times by the motor vehicle and receipt of a corresponding second response signal originating from the mobile identification transmitter by the motor vehicle. According to a further enhancement, the second request signal can be sent out with a prespecified intensity by the motor vehicle, and an intensity value of the second request signal measured at the location of the mobile identification transmitter is contained in the second response signal. According to a further enhancement, the authorization signal can be only transmitted if the measured intensity value falls below a predetermined threshold value.

According to a further embodiment, an access arrangement for a vehicle, may comprise a door sensor for detecting an open state of at least one door of the vehicle; a vehicle-side transceiver device for transmitting an authorization signal to a mobile identification transmitter, if a closed state of the least one door has been detected, with the authorization signal authorizing the mobile identification transmitter to lock the at least one door of the vehicle; a mobile identification transmitter comprising a mobile identification transmitter-side transceiver device for receiving the authorization signal, for emitting one or more request signals after receipt of the authorization signal, and for transmitting a locking signal to the motor vehicle, if no relevant response signal has been received by the motor vehicle for a predetermined number of request signals.

According to an enhancement, the vehicle-side transceiver device may transmit the authorization signal if an open state of the at least one door was detected by a door sensor before the closed state. According to a further enhancement, the access arrangement may further comprise a motor sensor for detecting an operational state of a drive device of the vehicle, where the vehicle-side transceiver device transmits the authorization signal if a deactivated state of the drive device of the vehicle was detected by the motor sensor. According to a further enhancement, the vehicle-side transceiver device, before transmitting the authorization signal, may check for the presence of the mobile identification transmitter in that it sends out one or more second request signals and by receipt of relevant second response signals from the mobile identification transmitter detects its presence. According to a further enhancement, the vehicle-side transceiver device can be designed to send out the second request signals with prespecified intensity, and the identification transmitter-side transceiver device can be designed to measure the intensity of the second request signals of the mobile identification transmitter as well as to provide the measured intensity value in the respective second response signals. According to a further enhancement, the vehicle-side transceiver device may transmit the authorization signal if the received measured intensity value falls below a predetermined threshold value.

### BRIEF DESCRIPTION OF THE DRAWINGS

Typical forms of embodiment of the present invention, which refer to the enclosed drawing, will be explained in greater detail below. The figures show:

FIG. 1 a schematic diagram of a keyless electronic access authorization system or an access arrangement in a vehicle according an embodiment;

FIG. 2 a schematic diagram to illustrate the states or conditions for controlling the locking on exit from the vehicle according to an embodiment;

FIG. 3 a flowchart to represent the operation of an access arrangement for controlling locking on exit from it vehicle in accordance with an embodiment.

### DETAILED DESCRIPTION

According to an embodiment, a method for locking a vehicle or at least one door of a vehicle includes the following steps. The opening state of the least one door is detected. Furthermore an authorization signal is transferred from the vehicle to a mobile identification transmitter if a closed state of at least one door is detected. In this case the mobile identification transmitter is authorized or empowered by the authorization signal to lock the vehicle. After receipt of the authorization signal the mobile identification transmitter now begins to emit one or more request signals. In such cases the request signals can be emitted at regular intervals of for example 250 milliseconds. If the motor vehicle now receives a respective request signal, it will respond to this by sending an appropriate response signal with a prespecified intensity back to the mobile identification transmitter. The mobile identification transmitter now evaluates whether it has received a specific response signal to a specific request signal and transfers a locking signal to the motor vehicle if no relevant response signal has been received for a predetermined number of request signals. The method described thus represents a simple option for automatic locking of a vehicle or of at least one of the vehicle doors, in which it is not necessary to detect in a complicated manner a specific movement pattern of the user of the vehicle or of an identification transmitter assigned to them but merely to detect how often a response signal from the vehicle has been received to a specific request signal from the mobile identification transmitter side.

In accordance with various embodiments the authorization signal will only be transmitted if an open state of at least one door was detected before the closed state. That means that, in the case in which a user wishes to leave the motor vehicle, that they will first open a door (open state) will get out of the car and will close the door behind them again (closed state). Thus the detection initially of an open state and then of a closed state should serve as a better criterion for the user having left the vehicle after opening and closing the at least one vehicle door.

The detection of the deactivated state of a drive device of the vehicle can serve as a further criterion for the transmission of the authorization signal from the motor vehicle to the mobile identification transmitter. The drive device can in this case be an electric motor or an internal combustion engine or similar of the vehicle. Use of this criterion further enables it to be ensured with a high degree of certainty that the authorization signal has very probably been emitted for a case in which the user intends to leave the motor vehicle or to move away from the vehicle. In this context it is also conceivable for a timing sequence to be established in which the specific data or states are detected. If the practical case in which a driver parks his vehicle after a long journey and wishes to leave the vehicle is used as a starting point, he will stop his vehicle at the side of the road for example, switch off the drive unit and then open the vehicle door in order to leave the vehicle. Thus there can be provision for the defined sequence for detection of data or states to first be that a switched-off engine or a deactivated drive unit of the vehicle is detected, then an open door state and finally a closed door state. Only if all three states are present or detected in the predetermined sequence is it then possible to transmit the authorization signal from the motor vehicle to the mobile identification transmitter.

In accordance with a further embodiment, the presence of the mobile identification transmitter is checked before the transmission of the authorization signal. This can be done for example by the vehicle sending out one or more second request signals and being able, by the receipt of corresponding second response signals from the mobile identification transmitter, to verify the latter's presence. Advantageously the vehicle sends the second request signals with a predetermined intensity which is so low that only mobile identification transmitters located in the immediate vicinity of the vehicle can receive the request signals at all. The immediate presence of the mobile identification transmitter can then be established in this way.

A further criterion for sending out the authorization signal can thus be that the presence of the mobile identification transmitter has been established. To make sure that the authorization signal has been transmitted to an identification transmitter assigned to the vehicle it is possible for an identification transmitter code to be requested by a second request signal from the vehicle which is then transmitted by a corresponding second response signal from the identification transmitter to the vehicle. Now the presence of a valid identification transmitter code can serve as a further criterion for the transmission of the authorization signal, said code being checked after being received by a control device or evaluation device intended for this purpose.

Furthermore it is possible that, as already mentioned above, the second request signals are sent out with a predetermined intensity by the vehicle, with the intensity value of a second request signal being measured by the mobile identification transmitter at its current location and this measured intensity value being provided in a second response signal which the mobile identification transmitter sends back to the vehicle. On the basis of the predetermined intensity value as well as the received measured intensity value from the mobile identification transmitter, the vehicle can now determine the distance between the mobile identification transmitter and the vehicle. In this case it is then possible that (as a further criterion) the authorization signal is only transmitted from the vehicle to the mobile identification transmitter when the intensity value measured by the mobile identification transmitter falls below a predetermined threshold value, i.e. if the distance between the mobile identification transmitter and the vehicle has exceeded a specific value.

According to a further embodiment, an access arrangement for a vehicle, especially a motor vehicle, is created which has the following features. It has a door sensor to record an opening state of at least one door of the vehicle. It also has a vehicle-side transceiver device for transmitting an authorization signal to a mobile identification transmitter (of a user or driver) which is configured for transmission of the authorization signal if a closed state of the least one door has been detected The authorization signal in this case authorizes the mobile identification transmitter to lock the vehicle or the at least one door. The access arrangement further features a mobile identification transmitter which includes an identification transmitter-side transceiver device which is initially configured for receiving the authorization signal. In addition the identification transmitter-side transceiver device is used to emit one or more request signals after obtaining or receiving the authorization signal and for transferring a locking signal to the vehicle if the respective response signal (from the vehicle) has not been received for a predetermined number of request signals. This means that a simple option for automatically locking a vehicle is created by the access arrangement shown if a user with the mobile identification transmitter, for example in the form of a key or a key ring, moves away from the vehicle, with the mobile identification transmitter determining when a specific distance has been covered at which the locking signal is to be sent to a vehicle in order to lock the latter.

In accordance with various embodiments different criteria can be defined which must be fulfilled before the authorization signal will be transmitted from the vehicle-side transceiver device to the mobile identification transmitter. In this case the criteria should ensure that for automatic locking of the vehicle it is the case that a user for example has parked his vehicle after a journey and wishes to leave the vehicle. In this case the vehicle-side transceiver device can only transmit the authorization signal if an open state of the at least one door has been detected by the door sensor before the closed state. It is further possible for the vehicle-side transceiver device only to transmit the authorization signal if a motor sensor has detected a deactivated state or a non-operational state of the drive device of the vehicle. In particular it can also be necessary for the transmission of the authorization signal for the correct chronological sequence of detecting the individual states of drive device and door to be adhered to. For example the transmission of the authorization signal can only take place if a deactivated state of the drive device is first detected, then an open state of the least one door and finally a closed state of the least one door.

In accordance with a further embodiment the vehicle-side transceiver device will check for the presence of the mobile identification transmitter before transmitting the authorization signal and only transmit the signal if it establishes that the mobile identification transmitter is present. The checking of the presence can in this case be undertaken by the vehicle-side transceiver device emitting at one all more second request signals and as a result of the receipt of the respective second response signals from the mobile identification transmitter, detecting the latter's presence.

Finally the vehicle-side of transceiver device can be equipped to emit the second request signals with a predetermined intensity, with the identification transmitter-side transceiver device been equipped to measure the intensity of the second request signals at the location of the mobile identification transmitter and to provide the measured intensity value in a respective second response signal. The vehicle-side transceiver device or a control device connected to this device can then compare the prespecified intensity value of a second request signal with the received measured intensity value (in the corresponding second response signal) and determine from this for example the distance between the mobile identification transmitter and the vehicle. A further criterion for emitting the authorization signal for the vehicle-side transceiver device can be that the received measured intensity value of a second request signal must be below a predetermined threshold value (or the distance between the mobile identification transmitter and the vehicle must exceed a specific distance).

According to a further embodiment, a vehicle, especially a motor vehicle, is created which features at least one door as well as an access arrangement as has just been described.

Various embodiments of the method presented above, provided they are otherwise able to be transferred to the access arrangement or to the vehicle, are also to be viewed as embodiments of the access arrangement or of the vehicle.

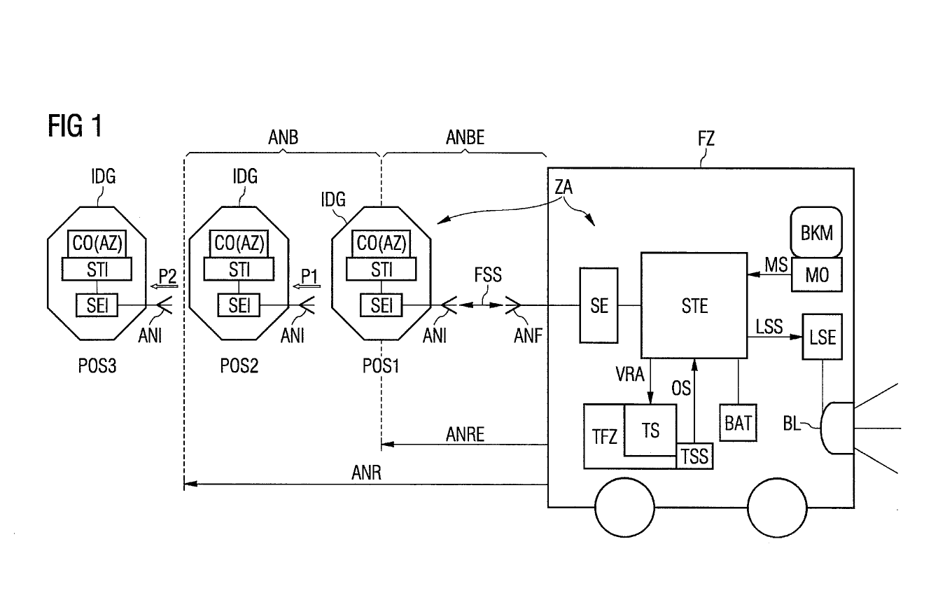

The reader is first referred to FIG. 1 in which an access authorization system or an access arrangement ZA is shown which is designed for use in a vehicle, here vehicle FZ The access arrangement in this case comprises (in a vehicle-side area, cf. right hand side of FIG. 1) a vehicle-side control device STE, which is supplied with power by a battery BAT. Although this is not shown, the battery BAT also used supplies power to further components of the vehicle. The control device STE is connected to a vehicle-side transceiver device SE which is able, by means of a vehicle-side antenna ANT, to communicate via a radio link FSS with a mobile identification transmitter IDG (which will be explained in more detail below). Furthermore the control device STE is connected to a door lock TS (which for example can stand for a central locking system) in order to activate the door lock by means of a locking instruction VRA. In addition the control device STE is connected to a light control device LSE, with the light control device LSE being able, after receiving a light control signal LSS, to activate or deactivate an illumination device BL, here for example in the form of a flasher or low headlight beam.

Furthermore the access arrangement ZA has a door sensor TSS which is configured to detect the opening state of at least one vehicle door, such as the door TFZ. In other words the door sensor TSS is able to detect whether the door TFZ is open or closed. The door sensor TSS can provide a corresponding open state signal OS either automatically or at the request of the control device STE. Furthermore the access arrangement ZA includes a motor sensor MO which is designed to detect the operating state of a drive device, such as the internal combustion engine BKM of the vehicle FZ. The detected operating state can then be fed by means of a signal MS automatically or on request to the control device STE.

As has been described above, the vehicle FZ can communicate via the radio link FSS with a mobile identification transmitter IDG (in an identification transmitter-side area, cf. left-hand side of FIG. 1). The prerequisite for bidirectional communication in this case is that the mobile identification transmitter IDG is located in a first proximity area ANBE in which the signals emitted from the vehicle-side antenna ANF still have a sufficient field strength to enable them to be correctly received by the mobile identification transmitter IDG. To receive signals from the vehicle-side antenna ANF a mobile identification transmitter IDG has an identification transmitter-side antenna ANI, which is connected to an identification transmitter-side transceiver device SEI, in order to process the receive signals or to create new signals which can eventually be emitted via the antenna ANI. Connected to the identification transmitter-side transceiver device is an identification transmitter-side control device STI, which is responsible on one hand for executing an authentication process with the vehicle FZ (especially with an access authorization check), but is also set up for triggering a locking signal to lock the vehicle FZ, as will be explained in greater detail below.

As will also be explained in greater detail below, the mobile identification transmitter IDG in FIG. 1 is shown in three different positions POS1, POS2 and POS3. In the first position POS1 the mobile identification transmitter is located in the first proximity area ANBE situated in the immediate vicinity of the vehicle, with bidirectional (radio) communication been possible between vehicle FZ and identification transmitter IDG in this area. In other words the field strength or intensity of the radio signals emitted by the antennas ANF and ANI is sufficient to enable them to be correctly received by the respective antenna of the other or of the received object. If however the mobile identification transmitter IDG with its user or the motor vehicle user is moving along the arrow PI away from the motor vehicle FZ, it will come to the second position POS2 at which it is located in a second proximity area ANB. This area is selected in this case so that although the intensity of the signals emitted by the identification transmitter IDG or the antenna ANI is sufficient to be correctly received by the antenna ANF of the vehicle FZ, the intensity of the signals emitted by the vehicle FZ or the antenna ANF is no longer sufficient to be correctly received by the antenna ANI of the identification transmitter IDG. If finally the mobile identification transmitter IDG is moving along arrow P2 further away from the vehicle, it will move out of the second proximity area ANB, in which case no further communication between the mobile identification transmitter IDG and the vehicle FZ is possible over the radio link FSS. It should be noted that the distance ANRE to identify the outer limit of the first proximity area ANBE can be around one meter, whereas the distance ANR to identify the outer limit of the second proximity area ANB can be around two to three meters.

Although only the locking up control of the access arrangement ZA is described in detail below, the access arrangement can of course also include access control for an authorized access to a vehicle such as the vehicle FZ. Such an access control can in this case be implemented as described above, with the association between at the mobile identification transmitter and the vehicle being checked in an authentication dialog between the mobile identification transmitter and the vehicle, and if the check is successful, the vehicle unlocking one or all of the vehicle doors.

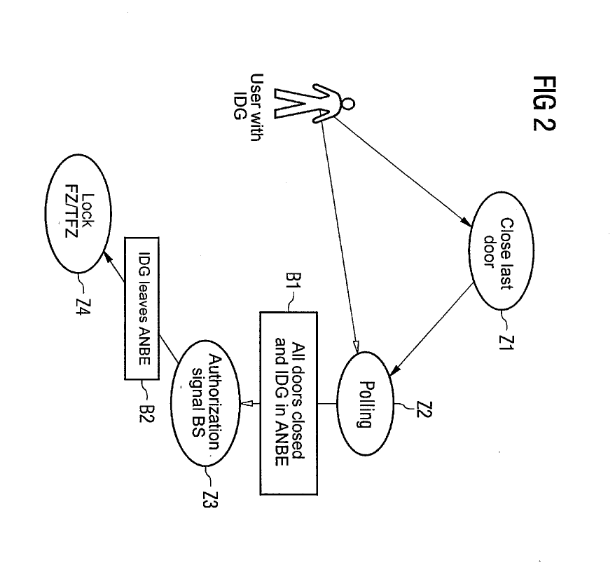

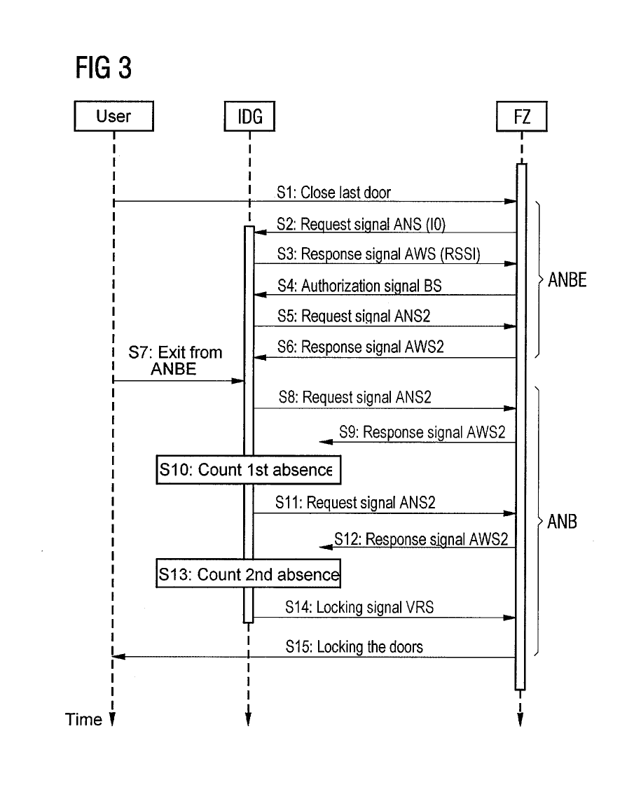

The reader is now referred to FIG. 2 in which a schematic diagram to illustrate the states or conditions for a locking control in accordance with one embodiment is shown. The initial state of FIG. 2 is that a vehicle, such as the vehicle FZ, has been parked by the user, with the drive unit or the internal combustion engine of the vehicle having been deactivated or switched off. The user or driver now opens his vehicle door (cf. TFZ in FIG. 1) and gets out of the vehicle. It is possible in this case that other people are being carried in the car and now likewise after opening the corresponding vehicle doors, such as the passenger door, get out of the vehicle. Subsequently the user's door TFZ and possibly further vehicle doors are closed (cf. Z1). It should be pointed out here that, as well as the door sensor TSS for the door TFZ and for each further door, corresponding door sensors are provided to detect the open state of the door which can forward the open state of the assigned door to a control device, such as the control device STE. If the control device STE now detects on the basis of respective opening state signals, that all vehicle doors—including the last vehicle door—are closed, it will attempt to establish whether a mobile identification transmitter of the user or driver is still located in the immediate vicinity of the vehicle. To this end the vehicle now undertakes “polling” (cf. Z2) in which it emits request signals via the vehicle-side antenna which can be answered by a mobile identification transmitter which is located in the immediate vicinity of the motor vehicle, i.e. in a first proximity area ANBE. If the mobile identification transmitter of the user is located in a first proximity area ANBE (cf. B1), it answers a received request signal with a corresponding response signal, whereby it typically provides an identification transmitter code in the response signal. If the identification transmitter code is correct an authorization process takes place in which the vehicle FZ transmits an authorization signal BS to the mobile identification transmitter IDG (cf. Z3) by which the mobile identification transmitter is authorized or empowered to lock the vehicle. As is described in greater detail with reference to FIG. 3, the identification transmitter IDG now begins to send one or more requests signals to the vehicle and checks whether a response signal from the vehicle has been received for a respective request signal. In this case the response signals of the vehicle are emitted with a field strength or intensity which is designed to so that only an identification transmitter located in the immediate vicinity of the vehicle (an identification transmitter located in the first proximity area ANBE) is able to receive the response signals of the vehicle (beyond a specific distance of the identification transmitter from a vehicle this identification transmitter will no longer receive the response signal). The identification transmitter now checks how often it no longer receives any response signal for a request signal. If a specific number of unanswered request signals is registered the identification transmitter can conclude from this that it has left the first proximity area ANBE (cf. B2), whereupon (authorized by the authorization signal) it sends a locking signal to the vehicle. After receipt of the locking signal by the antenna ANF or by the vehicle-side transceiver device SE, the signal is directed to the control device which for example on the basis of an identification transmitter code appended to the looking signal, finally checks the authorization of the mobile identification transmitter IDG to lock the vehicle. If the check is successful, the control device STE issues a locking instruction to the door lock TSS to lock the vehicle door TFZ or also to lock other vehicle doors (not shown) (cf. Z4). Accordingly a light control signal LSS can also be output to the light control device LSE in order to provide a confirmation for the user or the driver which signals to the user through a short blinking by means of the illumination device BL that locking has been successful.

Finally the reader is now referred to FIG. 3 in which a flow diagram for detailed illustration of the operation of the access arrangement ZA for a locking control according to an embodiment is shown. As with FIG. 2, the case used as the starting point is that in which a vehicle such as the vehicle FZ has been parked by a user or driver (after a journey), with the drive unit or internal combustion engine (or an electric motor) having been switched off. This type of switched-off state or non-operational state can for example be detected by the motor sensor MO and notified by means of the signal MS to the control device STE (cf. FIG. 1). The user or driver and possibly other passengers open their relevant vehicle doors, such as the door TFZ (which is detected for example by the door sensor TSS and further corresponding door sensors and can be notified to the control device STE), and close the relevant vehicle doors TFZ in accordance with step S1 (which is also detected by the door sensor TSS and possibly further door sensors and can be notified to the control device STE).

The closing or the closed state of the vehicle door TFZ, or with a number of passengers of the last vehicle door, can serve as a trigger for checking the presence of a mobile identification transmitter of the user or the driver in accordance with step S2. It is however also conceivable that an open state of a vehicle door and then a closed state must have been detected by at least one of the door sensors for the beginning of the presence checking according to step S2. In addition it is conceivable that for the beginning of the presence checking of the mobile identification transmitter in accordance with step S2, a switched-off or deactivated state of the drive unit, an open state of at least one vehicle door and finally a closed state of a vehicle door must have been detected as a criterion (by the control device STE). Depending on the embodiment of an access arrangement ZA, now after a specific criterion or a number of specific criteria are identified, as just listed, in step S2 a presence check of the mobile identification transmitter is started by the vehicle FZ emitting one or more request signals ANS with a prespecified intensity 10 which can be received by the mobile identification transmitter IDG. A mobile identification transmitter or its antenna ANI receives an emitted request signal ANS, with the identification transmitter-side transceiver device SEI determining the received intensity of the request signal. In a step S3 the identification transmitter-side transceiver device SEI then sends the measured intensity value or RSSI (Received signal Strength Indication) value in a response signal AWS back to the motor vehicle FZ. An identification transmitter code from the identification transmitter-side control device STI can also be contained in the response signal AWS. It is possible in this case for the request-response dialog of steps S2 and S3 just described to be executed repeatedly, with step S4 only being executed when the RSSI value of a request signal ANS measured by the identification transmitter IDG falls below a predetermined threshold value, which means that the mobile identification transmitter IDG is located at a specific distance from the vehicle FZ.

The sending out of the authorization signal BS in accordance with step S4, with which the mobile identification transmitter is authorized to lock the vehicle or one or all doors of this vehicle, can now occur in the simplest case if in step SI a closed state of the last (opened) vehicle door has been established and the presence of the mobile identification transmitter in the immediate vicinity of the vehicle, i.e. in the first proximity area ANB has been established (in accordance with steps S2 and S3). It is however also conceivable for further criteria to be checked after the existence of the (simple) criterion just mentioned. For example it can be checked only at this point whether before detection of the closed door state (cf. step S1) of one or all vehicle doors, an open door state of at least one door was detected and it can further be checked whether a drive unit was switched from an operating state into a non-operating state. If the criteria for a specific embodiment of the process are available to the lock control, the control device STE will transmit the authorization signal BS to the mobile identification transmitter IDG via the vehicle-side transceiver device SE and the antenna ANF.

The authorization signal BS is finally received by the antenna ANI and the identification transmitter-side control device SEI and fed to the identification transmitter-side control device STI. In response to the receipt of the authorization signal the control device STI now begins to send out one or more further request signals ANS2 in accordance with step S5. These further request signals ANS2 can then be received by the antenna ANF or the transceiver device SE of the vehicle and directed to the control device STE, which finally initiates the sending out via the transceiver device SE or the antenna ANF of a corresponding further response signal AWS2 in accordance with step S6. A further response signal AWS2 is sent out in this case with a prespecified intensity or field strength which is selected such that the further response signal AWS2 can only be received by a mobile identification transmitter IDG which is located in the vicinity of the vehicle FZ, i.e. in the first proximity area ANBE. While the mobile identification transmitter IDG is located in the first proximity area ANBE the further request-response dialog between the mobile identification transmitter and the vehicle can be executed (even several times).

If in step S7 the mobile occasion transmitter IDG moves (corresponding to the arrow P1 of FIG. 1) away from the motor vehicle in the second proximity area ANB, then although a further request signal ANS2 is received from the antenna ANF or the transceiver device SE of the vehicle FZ, because of its restricted range however the corresponding response signal AWS2 can no longer be received by the mobile identification transmitter IDG. In this case a counting device or a counter CO connected to the identification transmitter-side control device STI begins to count the number of further request signals sent out AWS2 for which no further response signal was received from the vehicle FZ. In other words, if the further response signal AWS2 in accordance with step S9 sent out in response to a further request signal ANS2 sent out in step S8 will no longer be received by the mobile identification transmitter since the mobile identification transmitter IDG is already located in the second proximity area ANB then the counter device counts in step S10 starting here from 0 to 1. It can generally be stated that a further response signal AWS2 counts as “not received” if it does not arrive at the mobile identification transmitter IDG within a prespecified time interval after the sending out of the further request signal ANS2.

If in accordance with the following dialog in steps S11 and S12, which corresponds to steps S8 and S9, once again no further response signal AWS2 is received from the mobile identification transmitter IDG, the counter CO in step S13 again increments to count by 1 and increases it from 1 to 2. Although it is not shown in FIG. 3, it is possible for a further request-response dialog in accordance with steps S8 and S9 or S11 and S12 to be repeated a number of times, with for a specific number AZ of further response signals not obtained or not received, the identification transmitter-side control device STI causing the identification transmitter-side transceiver device SEI to send out a locking signal VRS in step S14. This locking signal VRS is finally received by the antenna ANF and the transceiver device SE of the vehicle FZ, and directed to the control device STE. Then the control device STE sends in step S15 a locking instruction VRA to the door lock TS to lock the door TFZ or a number or doors or all doors of the vehicle. In this way an efficient locking control for a motor vehicle can be achieved by means of an access arrangement in which a mobile identification transmitter IDG automatically, on establishing a movement away from a vehicle, locks the latter.

In conclusion it should be stated that the signals described in FIG. 3 can be LF (Low Frequency) signals, which for example are transmitted in the 125 kHz range.

It should further be pointed out that a light control signal LSS can optionally be output to the light control device LSE by the control device after a successful locking or after output of the locking instruction, as a confirmation or indication to a user assigned to the mobile identification transmitter IDG, so that the light control device for example causes a short blinking of the illumination device BL (for example in the form of the indicators or of the low-beam headlights). As well as an optical indication of a successful locking of the door it is also conceivable for the vehicle to output an audible signal triggered by the control device STE, for example in the form of a short horn sound etc..

1. A method for locking at least one door of a vehicle with the following steps:
Detecting the open state of the least one door;
Transmission of an authorization signal from the vehicle to a mobile identification transmitter, if a closed state of the least one door is detected, with the mobile identification transmitter being authorized by the authorization signal to lock the vehicle;
Emission of one or more request signals from the mobile identification transmitter after receipt of the authorization signal;
Sending of respective response signals with a predetermined intensity by of the vehicle in response to the receipt of a request signal;
Transmission of a locking signal from the mobile identification transmitter to the vehicle, if a relevant response signal has not been received for a predetermined number of request signals.

2. The method according to claim 1, wherein the authorization is transmitted if an open state of at least one door has been detected before the closed state.

3. The method according to claim 1, wherein the authorization signal is transmitted if a deactivated state of a drive device of the vehicle has been detected.

4. Method according to claim 1, wherein before transmission of the authorization signal the presence of the mobile identification transmitter in the vicinity of the vehicle is checked.

5. The method according to claim 4, wherein the presence is checked by a second request signal being sent out once or a number of times by the motor vehicle and receipt of a corresponding second response signal originating from the mobile identification transmitter by the motor vehicle.

6. The method according to claim 5, wherein the second request signal is sent out with a prespecified intensity by the motor vehicle, and an intensity value of the second request signal measured at the location of the mobile identification transmitter is contained in the second response signal.

7. The method according to claim 6, wherein the authorization signal is only transmitted if the measured intensity value falls below a predetermined threshold value.

8. An access arrangement for a vehicle, comprising:
a door sensor for detecting an open state of at least one door of the vehicle;
a vehicle-side transceiver device for transmitting an authorization signal to a mobile identification transmitter, if a closed state of the least one door has been detected, with the authorization signal authorizing the mobile identification transmitter to lock the at least one door of the vehicle;
a mobile identification transmitter comprising a mobile identification transmitter-side transceiver device
for receiving the authorization signal,
for emitting one or more request signals after receipt of the authorization signal, and
for transmitting a locking signal to the vehicle, if no relevant response signal has been received by the vehicle for a predetermined number of request signals.

9. The access arrangement according to claim 8, wherein the vehicle-side transceiver device transmits the authorization signal if an open state of the at least one door was detected by a door sensor before the closed state.

10. The access arrangement according to claim 8, further comprising a motor sensor for detecting an operational state of a drive device of the vehicle, where the vehicle-side transceiver device transmits the authorization signal if a deactivated state of the drive device of the vehicle was detected by the motor sensor.

11. The access arrangement according to claim 8, wherein the vehicle-side transceiver device, before transmitting the authorization signal, checks for the presence of the mobile identification transmitter in that it sends out one or more second request signals and by receipt of relevant second response signals from the mobile identification transmitter detects its presence.

12. The access arrangement according to claim 11, wherein the vehicle-side transceiver device is designed to send out the second request signals with prespecified intensity, and the identification transmitter-side transceiver device is designed to measure the intensity of the second request signals of the mobile identification transmitter as well as to provide the measured intensity value in the respective second response signals.

13. The access arrangement according to claim 12, wherein the vehicle-side transceiver device transmits the authorization signal if the received measured intensity value falls below a predetermined threshold value.

14. A vehicle, especially motor vehicle, comprising:
at least one door;
an access arrangement, comprising:
a door sensor for detecting an open state of the at least one door;
a vehicle-side transceiver device for transmitting an authorization signal to a mobile identification transmitter, if a closed state of the least one door has been detected, with the authorization signal authorizing the mobile identification transmitter to lock the at least one door of the vehicle;
a mobile identification transmitter comprising a mobile identification transmitter-side transceiver device for receiving the authorization signal,
for emitting one or more request signals after receipt of the authorization signal, and
for transmitting a locking signal to the motor vehicle, if no relevant response signal has been received by the motor vehicle for a predetermined number of request signals.

15. The vehicle according to claim 14, wherein the vehicle-side transceiver device transmits the authorization signal if an open state of the at least one door was detected by a door sensor before the closed state.

16. The vehicle according to claim 14, further comprising a motor sensor for detecting an operational state of a drive device of the vehicle, where the vehicle-side transceiver device transmits the authorization signal if a deactivated state of the drive device of the vehicle was detected by the motor sensor.

17. The vehicle according to claim 14, wherein the vehicle-side transceiver device, before transmitting the authorization signal, checks for the presence of the mobile identification transmitter in that it sends out one or more second request signals and by receipt of relevant second response signals from the mobile identification transmitter detects its presence.

18. The vehicle according to claim 17, wherein the vehicle-side transceiver device is designed to send out the second request signals with prespecified intensity, and the identification transmitter-side transceiver device is designed to measure the intensity of the second request signals of the mobile identification transmitter as well as to provide the measured intensity value in the respective second response signals.

19. The vehicle according to claim 18, wherein the vehicle-side transceiver device transmits the authorization signal if the received measured intensity value falls below a predetermined threshold value.
